(19) United States
(12) Patent Application Publication
(10) Pub. No.: US 2005/0029706 A1
(43) Pub. Date: Feb. 10, 2005

(54) Method of making aesthetically unique useful objects

(76) Inventor: Jeffrey M. Weyant, Chicago, IL (US)

Correspondence Address: MICHAEL BEST & FRIEDRICH LLC, 401 NORTH MICHIGAN AVENUE, SUITE 1900, CHICAGO, IL, 60611-4212, US

(21) Appl. No.: 10/636,116

(22) Filed: Aug. 7, 2003

(51) Int. Cl. B29C 33/40

(52) U.S. Cl. 264/219; 264/310; 264/222

(57) ABSTRACT

A method of molding unique hollow polyurethane objects by providing a model of the object, preparing a fiberglass mold of the model, preparing and introducing a polyurethane resin into the fiberglass mold, and rotocasting to distribute the polyurethane resin along the inner surfaces of the fiberglass mold.

### FIELD OF THE INVENTION

This invention relates to methods of molding unique hollow polyurethane objects and, more particularly, to a method of making aesthetically unique useful objects by providing a three-dimensional model of the object, forming a fiberglass mold of the three-dimensional model, and rotocasting the fiberglass mold to make the aesthetically unique useful object.

### BACKGROUND OF THE INVENTION

Fashion forms are one type of useful object in which the aesthetics of the object is very important. Fashion forms are used to display clothing in store windows, on selling displays, etc. In the past, fashion forms typically have been made from solid foam material or fiberglass resin. For example, particularly detailed solid foam fashion forms have been made in the past by directly casting fiberglass molds from human models' bodies, and using the fiberglass molds, held in a stationary position, to prepare the solid foam fashion forms from appropriate foam-forming materials. Unfortunately, solid fashion forms are fairly easily damaged, since the surface of the material is not resilient and is easily dented, chipped or cut. Furthermore, solid foam fashion forms are expensive to manufacture due to the substantial amount of foam material present in each of the forms.

If equally detailed, hollow, economical and resilient fashion forms could be prepared, it would constitute an important contribution to the art. For example, if such highly detailed hollow fashion forms could be made from a durable, resilient material like polyurethane, and if they could be prepared easily and economically, a new improved genre of fashion forms would be at hand.

Likewise, if other aesthetically unique useful articles could be made from a durable, resilient material like polyurethane, and if they could be prepared easily and economically, a further important new invention would be at hand. Examples of such other types of aesthetically unique useful objects are shelves and other display paraphernalia which have a unique sculpted look. The unique sculpted look of the shelves and other display paraphernalia draws attention to the objects displayed thereon. Yet, sculpting the products on a one-by-one basis is not economically feasible.

Unfortunately, in the past hollow polyurethane objects have been molded in metallic molds which typically are quite expensive and do not produce products commensurate in detail with conventional solid foam fashion forms or with other highly detailed aesthetically unique useful articles. Interestingly, no one in the past has thought to mold hollow polyurethane products like these in fiberglass molds, because such molds would not be expected to have temperature and other properties necessary for successfully and efficiently molding polyurethane to produce such highly detailed products.

### SUMMARY OF THE INVENTION

This invention consists of a method for making aesthetically unique useful objects like fashion forms, shelves and other display paraphernalia by providing a three-dimensional model of the object, preparing a mold from the model and making a positive form of the model using the mold. Once this is done, a fiberglass mold is made of the positive form, and an appropriate polyurethane resin is prepared and introduced into the fiberglass mold which is rotocast to distribute the polyurethane resin along the inner surface of the fiberglass mold. Typically, this polyurethane resin is permitted to gel, whereupon the mold is opened and the rotocast form removed so that the curing process can continue after it is removed from the form.

### BRIEF DESCRIPTION OF THE DRAWINGS

The above as well as other objects and advantages of the invention will become apparent from the following detailed description of the preferred embodiments in which reference is made to the accompanying drawings where:

FIG. 1 is a fiberglass mold of the type used in the method of the present invention;

FIG. 2 is a fashion form produced in accordance with the method of the present invention using the fiberglass mold of FIG. 1;

FIG. 3 is a perspective view of a tray made in accordance with the method of the present invention;

FIG. 4 is a perspective view of a shelving unit or etagere comprising a series of circular aesthetically unique shelves supported by a metallic support unit;

FIG. 5 is a perspective view of another shelving unit with a series of aesthetically unique shelves made in accordance with the present invention; and

FIGS. 6A-6C illustrate, in plan and cross-sectional views, a series of alternative shelves and other display paraphernalia which have unique sculpted looks which may be made in accordance with the present invention.

### DETAILED DESCRIPTION OF THE PREFERRED EMBODIMENT

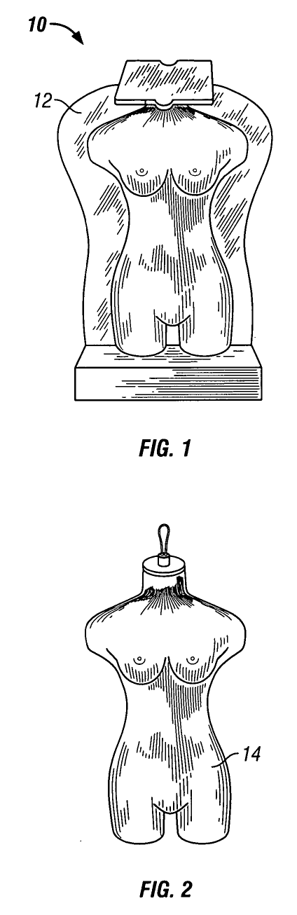

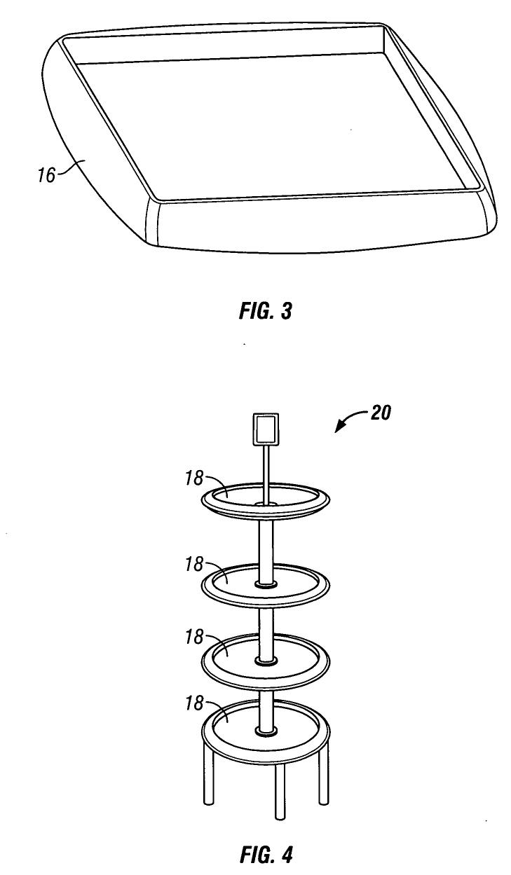

As described in some detail below, in accordance with one embodiment of the present invention, a fiberglass mold 10 as illustrated in FIG. 1 is formed from a human model's body. The resulting mold is strikingly detailed and, surprisingly, can be used to mold hollow polyurethane fashion forms as shown in FIG. 2.

Fiberglass molds 10 may be prepared as follows. A model is chosen and he/she is dressed in a form-fitting bodysuit. Wetted plaster bandages of the type typically used in casting fractured bones, etc. are wound about the model's limbs and torso, with the bandages pressed into the body curves and crevices, as appropriate. The plaster bandages are permitted to cure and then a seam is formed along the entire perimeter of the model's body, and the cast is pulled away from the model in two halves and a flange for clamping is formed.

Once removed from the model, the plaster mold halves are cleaned, checked and shellacked and then rejoined, leaving a pour hole at the top. Then, about six-pound density pouring urethane foam is introduced into the plaster bandage mold to make a positive form of the model.

This positive form is then also cleaned and checked, and then the hollow fiberglass mold 10, with its two corresponding halves joined at flanges 12, is made by laying up gelcoat and fiberglass on the surface of the positive urethane foam form of the model. Once the fiberglass mold is completed and ready to be used, its interior surface is coated with a wax release material such as Johnson floor wax. The polyurethane resin is then mixed up, heated and introduced through an inlet into the fiberglass mold which preferably is also preheated. A coloring agent may be added to the mix, if desired. When a resin that should be heated to about 100° F. to 120° F. is used, the mold should be preheated to about 120° F. A coloring agent may be added to the polyurethane if desired. The mold typically does not have to be further heated, because the polyurethane mixture exotherms as it cures, providing continuous heating of the mold.

The mold containing the polyurethane is then closed up by clamping, placed in a conventional rotocast machine and rotated in accordance with known techniques at an x/y axis speed determined by trial and error to distribute the polyurethane resin along the inner surface of the fiberglass mold. Sufficient polyurethane resin is provided to produce a final fashion form product having a thickness of about from about ⅛ to 3/16 inch. Preferably the quantity of resin will be chosen to produce a fashion form with a thickness of about 3/16 inch.

Preferably, the polyurethane is formulated so that it begins to gel in about 3 to 5 minutes after the resin components are mixed together. This may be determined by trial and error. If the gelling time is too long, it would be difficult to produce a satisfactory product because sagging or pulling away from the wall of the mold would occur. If the gelling time is too short, the polyurethane will form clumps before it is able to spread along the surface of the mold.

When the rotocasting is completed, the mold is allowed to stand for about 15 minutes at room temperature in order to begin the cooling of the fashion form waiting therein. The molded form is still in the green state at this point (not fully cooled or fully cured) which facilitates removal of resin overflow on the form as well as cleaning up form seams, etc. The mold is opened with the form in this green state and the form is removed and allowed to fully cure, preferably at room temperature, over a period of at least 30 minutes. The resulting product 14, which is shown in FIG. 2, is strong, highly detailed, resilient and “colored through.” By “colored through”, it is meant that the polyurethane is of the same color throughout so that a scratch of the surface of the form will not stand out due to exposure in the scratch of a differently colored material. Also, the resulting product has some give, but bounces back to its original shape when lightly deformed by pressing the surface of the form.

The resin used in making the forms is a polyurethane which will have a molecular weight and degree of crosslinking that will give it sufficient hardness and toughness to resist scratching. The molecular weight should also be chosen to insure cure characteristics that will permit the polyurethane resin to be distributed within the mold before any significant curing begins, yet insure that once distributed, the resin cures in a reasonable period of time, and can be removed from the mold. Also, fillers such as fiberglass particles may be introduced into the resin in order to, for example, reduce the cost of the resulting fashion form.

Commercial polyurethane polymers are typically made by the reaction of a diisocyanate with a diol molecule containing at least two active hydrogens, where an active hydrogen is defined as a hydrogen that can be replaced by sodium. The reaction, which is self-sustaining and without byproduct formation, is a relatively easily controlled polymerization which is often named polyaddition, and may be represented by the reaction:

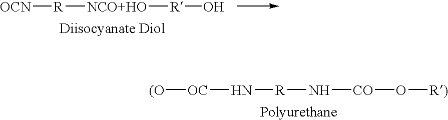

One commercial polyurethane resin that can be used in the practice of the invention is available from BASF Corporation under #11604-1-93-133R. It is a gray liquid with a viscosity of 805 cups at 77° F. (25° C.) and a density of 1.065 g/cc (8.83 lb./gal. at 77° F.). Other polyurethane resins that have appropriate cure characteristics and produce a polyurethane with the desired hardness and toughness can be used in the practice of the invention. Such resins can be readily identified by those skilled in the art and, where necessary, fine-tuned by simple trial and error testing.

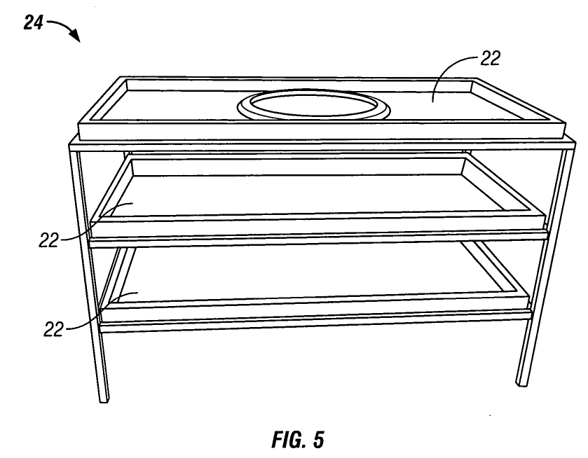

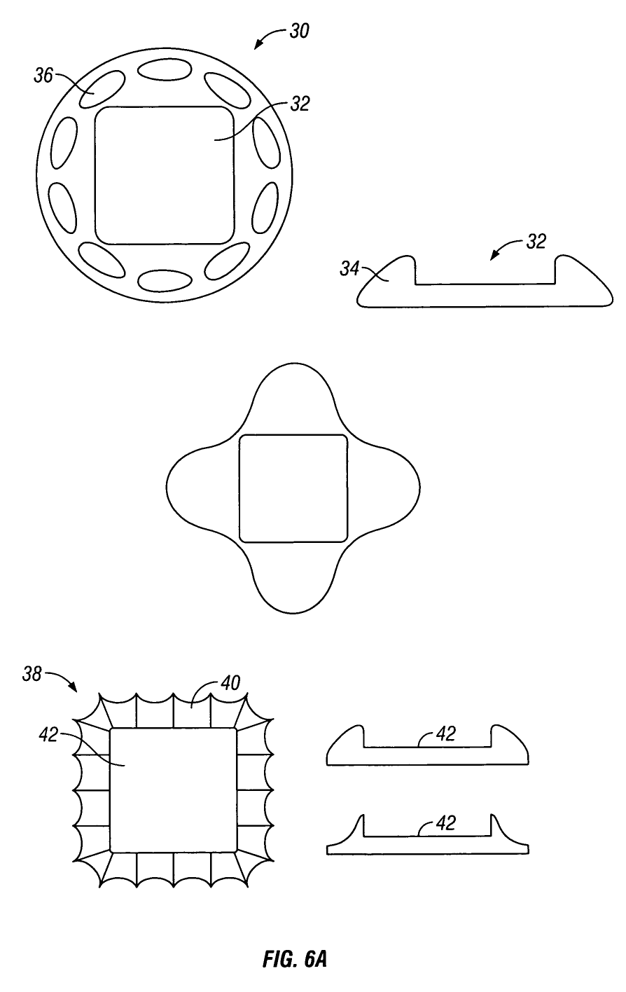

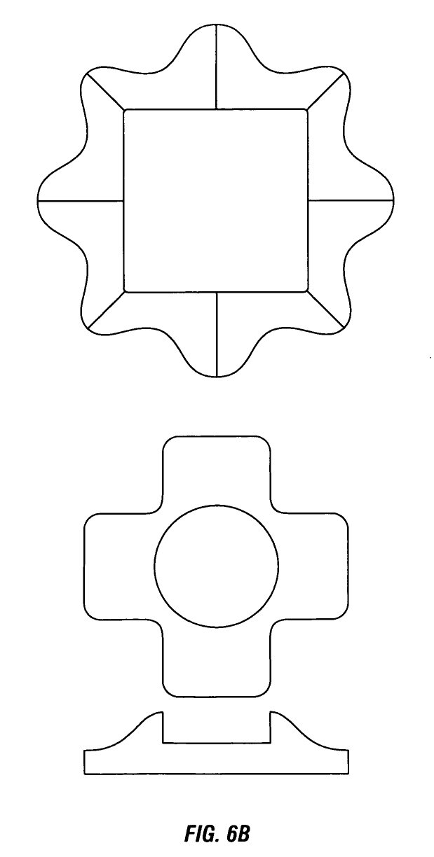

Other aesthetically unique useful objects may be made in the same way as the fashion mold described above. Thus, for example, a tray 16 (FIG. 3), or the individual shelves 18 of the four-shelve etagere 20 of FIG. 4 or the three shelves 22 of the etagere 24 of FIG. 5 may be made by first sculpting the individual tray or shelf from clay and permitting the clay to harden. Then, this clay model is covered by wetted plaster bandages, which are pressed into the curves and crevices of the clay model. The plaster bandages are permitted to cure and then a seam is formed along the perimeter of the model, and the cast is pulled away from the model in two halves.

Once removed from the clay model, the plaster molds are cleaned, checked and shellacked. They are then rejoined by screw clamps along the flanges and with duct tape, leaving a pour hole in the top. Then poured urethane foam is introduced into the mold to make a positive form.

The positive form of the shelf (or tray, etc.) is cleaned and checked, and a fiberglass mold is made by laying up gel coat and fiberglass. A flange is formed on the cast for later clamping. Once the fiberglass mold is completed, its interior surface is coated with a wax release material. Then, the polyurethane resin is mixed up (including a coloring agent, if desired), heated and introduced through an inlet in the fiberglass mold which preferably is also preheated.

Next, the mold containing the polyurethane is closed up by clamping, placed in a conventional rotocast machine and rotated to distribute the polyurethane resin along the inner surface of the fiberglass mold. Sufficient polyurethane resin is provided to produce a final shelf (or tray, etc.) having a thickness of about ⅛-3/16 inches. When the rotocasting is completed, the mold is allowed to stand for about 15 minutes at room temperature to begin the cooling process. The mold is then opened with the form in the green state and the form is removed and allowed to slowly cure at room temperature.

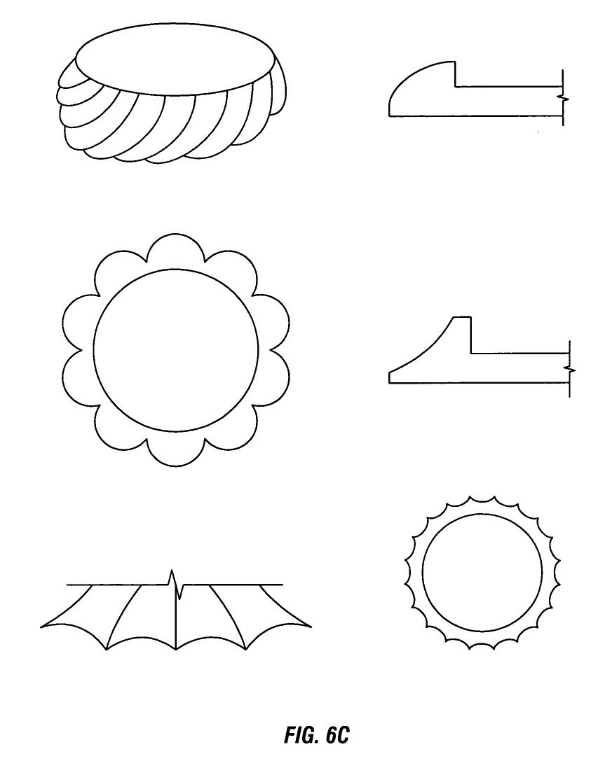

As noted earlier, the present method makes it possible to simply and economically produce hollow polyurethane shelves and other display paraphernalia which have a unique sculpted look. Examples of such products are illustrated in FIGS. 6A-6C. For example, a shelf 30 is shown with a square central cavity 32 within a round bullnose profile 34 having debossed elliptical shapes 36 on its surface. Shelf 38 is a generally square shape with flutes 40 along its periphery and a central inset square cavity 42. The remaining shelf designs are illustrative of other shelf designs which may be used.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for making aesthetically unique useful objects comprising:
providing a three-dimensional model of an object;
preparing a plaster mold of the model;
making a positive form of the model in the plaster mold;
making a fiberglass mold of the positive form;
preparing and introducing a polyurethane resin into the fiberglass mold;
rotocasting the polyurethane resin within the fiberglass mold to produce a rotocast form; and
permitting the rotocast form to cure.

2. The method of claim 1 in which the aesthetically unique useful object is a fashion form and the three-dimensional model is cast from a human model's body.

3. The method of claim 2 in which the three-dimensional model is made by applying water-wetted plaster bandages to the model's body, pressing the bandages into body curves and crevices, and permitting the plaster bandages to cure.

4. The method of claim 1 in which the aesthetically unique useful object is a shelf.

5. The method of claim 4 in which the three-dimensional model of the shelf is formed from clay.

6. The method of claim 5 in which the plaster mold of the clay model is made by applying water-wetted plaster bandages to the clay model, pressing the bandages into the clay model curves and crevices, and permitting the plaster bandages to cure.

7. The method of claim 1 in which the polyurethane resin is distributed along the inner surface of the fiberglass mold during the rotocasting and the polyurethane is permitted to reach the green state thereafter, whereupon the fiberglass mold is opened and the form is removed and allowed to fully cure.

8. The method of claim 1 in which a coloring agent is added to the polyurethane before it is introduced into the fiberglass mold.

9. The method of claim 1 in which the fiberglass mold is pre-heated before introducing the polyurethane resin.

10. The method of claim 1 in which sufficient polyurethane resin is provided to produce a final product having a thickness of from about ⅛ to 3/16 inch.

11. The method of claim 1 in which the quantity of resin is chosen to produce a product having a thickness of about 3/16 inch.

12. The method of claim 1 in which the polyurethane is formulated so that it begins to gel about 3 to 5 minutes after it is mixed.

13. The method of claim 1 in which fiberglass is added to the polyurethane.

14. A method for making a fashion form comprising:
providing a human model;
preparing a plaster mold of the model;
making a positive form of the model;
making a fiberglass mold of the positive form;
preparing and introducing a polyurethane resin into the fiberglass mold;
rotocasting to distribute the polyurethane resin along the inner surface of the fiberglass mold to produce a rotocast form;
permitting the polyurethane to gel;
opening the mold; and
permitting the rotocast form to cure.

15. The method of claim 14 in which the plaster mold is made by applying water-wetted plaster bandages to the model's body, pressing the bandages into body curves and crevices, and permitting the plaster bandages to cure.

16. The method of claim 14 in which a coloring agent is added to the polyurethane before it is introduced into the fiberglass mold.

17. The method of claim 14 in which the fiberglass mold is pre-heated before introducing the polyurethane resin.

18. The method of claim 14 in which sufficient polyurethane resin is provided to produce a final product having a thickness of from about ⅛ to 3/16 inch.

19. A method for making aesthetically unique useful objects comprising:
providing a three-dimensional model of an object;
preparing a plaster mold of the model;
making a positive form of the model in the plaster mold;
making a fiberglass mold of the positive form;
preheating the fiberglass mold;
preparing and introducing a polyurethane resin including a coloring agent into the fiberglass mold;
rotocasting to distribute the polyurethane resin along the inner surface of the fiberglass mold;
permitting the polyurethane to gel;
opening the mold; and
permitting the rotocast form to cure.

20. The method of claim 19 in which sufficient polyurethane resin is provided to produce a final product having a thickness of from about ⅛ to 3/16 inch.
